(19) United States
(12) Patent Application Publication
(10) Pub. No.: US 2015/0311584 A1
(43) Pub. Date: Oct. 29, 2015

(54) WIDEBAND WHIP ANTENNA

(71) Applicant: GALTRONICS CORPORATION LTD., Tiberias (IL)

(72) Inventors: Gennady BABITSKI, Haifa (IL); Matti MARTISKAINEN, Tiberias Illit (IL); Victor HOEPFNER, Poria Elite (IL)

(73) Assignee: GALTRONICS CORPORATION LTD., Tiberias (IL)

(21) Appl. No.: 14/439,254

(22) PCT Filed: Oct. 31, 2013
(86) PCT No.: PCT/IL13/50896

§ 371 Date: Apr. 29, 2015

Related U.S. Application Data
(60) Provisional application No. 61/720,756, filed on Oct. 31, 2012.
(60) Provisional application No. 61/722,864, filed on Nov. 6, 2012.

(51) Int. Cl. H01Q 1/36; H01Q 9/28

(52) U.S. Cl. CPC H01Q 1/36; H01Q 1/362; H01Q 9/28

(57) ABSTRACT

A wideband antenna, including a radio-frequency connector providing a radio-frequency current, an elongate radiating element galvanically connected to the radio-frequency connector, the elongate radiating element forming a galvanic radio-frequency current path for the radio-frequency current and at least one generally cylindrical conductive element enclosing at least a portion of the elongate radiating element and forming a capacitive radio-frequency current path for the radio-frequency current.

### SUMMARY OF THE INVENTION

The present invention seeks to provide an improved whip antenna having wideband performance.

There is thus provided in accordance with a preferred embodiment of the present invention a wideband antenna, including a radio-frequency connector providing a radio-frequency current, an elongate radiating element galvanically connected to the radio-frequency connector, the elongate radiating element forming a galvanic radio-frequency current path for the radio-frequency current and at least one generally cylindrical conductive element enclosing at least a portion of the elongate radiating element and forming a capacitive radio-frequency current path for the radio-frequency current.

Preferably, the radio-frequency connector includes a coaxial connector including a conductive outer connector body and a conductive inner pin.

Preferably, the elongate radiating element has a base end, the base end being galvanically connected to the conductive inner pin.

Preferably, the elongate radiating element is mounted on the radio-frequency connector.

In accordance with a preferred embodiment of the present invention, the elongate radiating element includes a monopole.

Preferably, the at least one generally cylindrical conductive element includes a conductive tube enclosing the monopole and separated therefrom by a dielectric spacer, the conductive tube overlapping with the conductive outer connector body so as to form the capacitive radio-frequency current path.

Preferably, there is no galvanic contact between the at least one generally cylindrical conductive element and the elongate radiating element.

In accordance with another preferred embodiment of the present invention, the radio-frequency connector also includes an inner coaxial wire.

Preferably, the elongate radiating element has a base end, the base end being galvanically connected to the inner coaxial wire.

Preferably, the antenna also includes a balun galvanically connected to the radio-frequency connector.

Preferably, the elongate radiating element forms a first arm of a dipole and the balun forms a second arm of the dipole.

Preferably, the at least one generally cylindrical conductive element includes a conductive tube enclosing the elongate radiating element and separated therefrom by a dielectric spacer, the conductive tube overlapping with the balun so as to form the capacitive radio-frequency current path.

In accordance with a further preferred embodiment of the present invention, the antenna also includes a matching circuit for matching an impedance of the elongate radiating element to an impedance of the radio-frequency connector.

Preferably, the at least one generally cylindrical conductive element includes a conductive choke, the conductive choke enclosing a portion of the elongate radiating element and being separated therefrom by a dielectric spacer.

Preferably, the conductive choke overlaps with a portion of the conductive outer connector body so as to form the capacitive radio-frequency current path.

Preferably, the conductive choke forms a part of the matching circuit.

Preferably, the matching circuit also includes a conductive bushing and a coil.

Preferably, the conductive choke capacitively feeds the elongate radiating element.

In accordance with yet another preferred embodiment of the present invention, the at least one generally cylindrical conductive element includes at least one conductive sleeve enclosing a portion of the elongate radiating element and separated therefrom by a dielectric spacer.

Preferably, the antenna also includes a helical radiating element surrounding the elongate radiating element and the at least one conductive sleeve.

Preferably, the at least one conductive sleeve filters the radio-frequency current along the helical radiating element.

Preferably, the helical radiating element radiates in a first VHF 136-174 MHz frequency band.

Preferably, the elongate radiating element is capacitively coupled to the at least one conductive sleeve to form a composite high frequency radiating element.

Preferably, the antenna is a tri-band antenna.

There is further provided in accordance with another preferred embodiment of the present invention a wideband antenna including a radio-frequency connector providing a radio-frequency current, a monopole radiating element galvanically connected to the radio-frequency connector, the monopole radiating element forming a galvanic radio-frequency current path for the radio-frequency current and a tubular conductive radiating element enclosing at least a portion of the monopole radiating element and forming a capacitive radio-frequency current path for the radio-frequency current.

There is also provided in accordance with yet another preferred embodiment of the present invention a wideband antenna including a radio-frequency connector providing a radio-frequency current, an elongate radiating element galvanically connected to the radio-frequency connector, the elongate radiating element forming a first arm of a dipole and providing a galvanic radio-frequency current path for the radio-frequency current, a balun galvanically connected to the radio-frequency connector, the balun forming a second arm of the dipole and a generally cylindrical conductive radiating element enclosing at least a portion of the elongate radiating element and forming a capacitive radio-frequency current path for the radio-frequency current.

There is provided in accordance with yet a further preferred embodiment of the present invention a wideband antenna including a radio-frequency connector providing a radio-frequency current, a monopole radiating element galvanically connected to the radio-frequency connector, the monopole radiating element forming a galvanic radio-frequency current path for the radio-frequency current and a conductive choke enclosing at least a portion of the monopole radiating element and the radio-frequency connector and forming a capacitive radio-frequency current path for the radio-frequency current.

There is further provided in accordance with another preferred embodiment of the present invention a wideband antenna including a radio-frequency connector providing a radio-frequency current, an elongate radiating element galvanically connected to the radio-frequency connector, the elongate radiating element forming a galvanic radio-frequency current path for the radio-frequency current, a helical radiating element galvanically connected to the radio-frequency connector and surrounding the elongate radiating element and at least one cylindrical conductive element enclosing at least a portion of the elongate radiating element and forming a capacitive radio-frequency current path for the radio-frequency current.

### BRIEF DESCRIPTION OF THE DRAWINGS

The present invention will be understood and appreciated more fully from the following detailed description, taken in conjunction with the drawings in which:

FIGS. 1A and 1B are simplified respective perspective and cross-sectional view illustrations of an antenna constructed and operative in accordance with a preferred embodiment of the present invention;

FIGS. 2A and 2B are simplified respective perspective and cross-sectional view illustrations of an antenna constructed and operative in accordance with another preferred embodiment of the present invention;

FIGS. 3A and 3B are simplified respective perspective and cross-sectional view illustrations of an antenna constructed and operative in accordance with a further preferred embodiment of the present invention; and

FIGS. 4A and 4B are simplified respective perspective and cross-sectional view illustrations of an antenna constructed and operative in accordance with yet another preferred embodiment of the present invention.

### DETAILED DESCRIPTION OF PREFERRED EMBODIMENTS

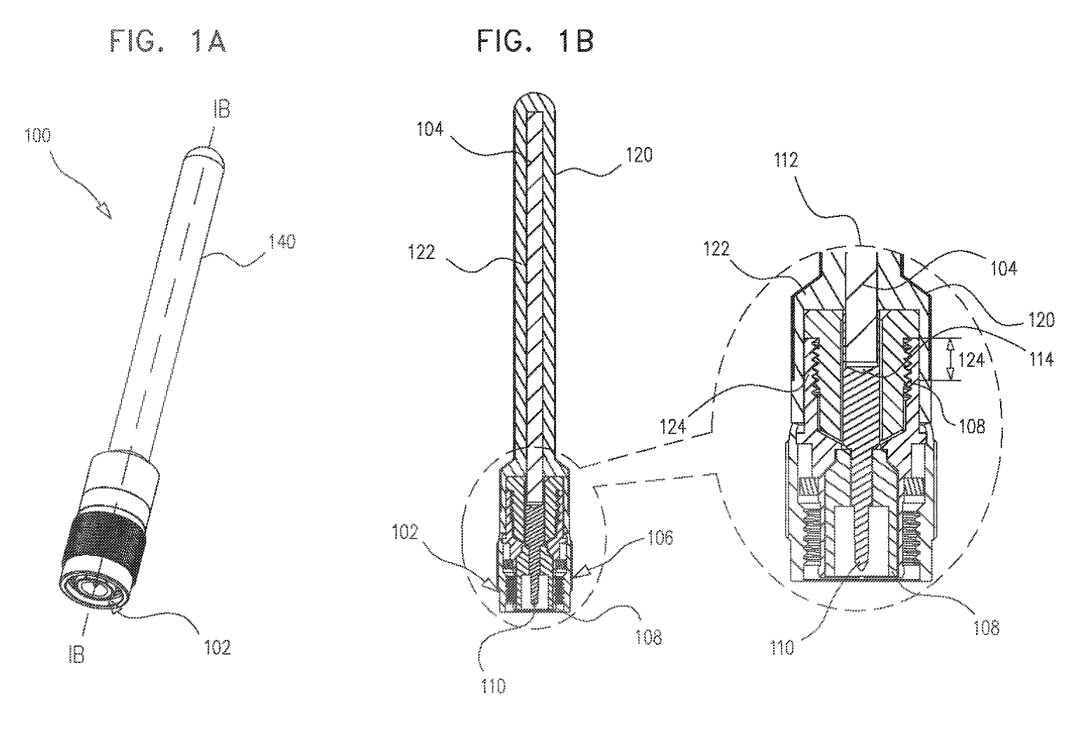

Reference is now made to FIGS. 1A and 1B, which are simplified respective perspective and cross-sectional view illustrations of an antenna constructed and operative in accordance with a preferred embodiment of the present invention.

As seen in FIGS. 1A and 1B, there is provided an antenna 100. Antenna 100 preferably includes a radio-frequency (RF) connector 102 providing an RF current to antenna 100, and an elongate radiating element 104 galvanically connected thereto. Here, by way of example, RF connector 102 is shown to be embodied as a coaxial connector 106 having a conductive outer connector body 108 and a conductive inner pin 110. As seen most clearly at enlargement 112, elongate radiating element 104 is preferably galvanically connected at a base end 114 thereof to inner pin 110 of coaxial connector 106.

It is appreciated by one skilled in the art that due to the galvanic connection between RF connector 102 and elongate radiating element 104, elongate radiating element 104 forms a galvanic RF current path for the RF current provided by RF connector 102.

Antenna 100 further includes at least one generally cylindrical conductive element enclosing at least a portion of elongate radiating element 104, here embodied, by way of example, as a cylindrical conductive tube 120 coextensive with elongate radiating element 104 and separated therefrom by a dielectric spacer 122. Tube 120 preferably extends beyond base end 114 of elongate radiating element 104 so as to overlap with a portion of outer connector body 108 in overlap region 124.

As best seen at enlargement 112, the structure formed in overlap region 124 by mutually overlapping conductive tube 120 and conductive outer connector body 108, separated by dielectric spacer 122, is a capacitive structure, leading to capacitive coupling between outer connector body 108 and conductive tube 120. Preferably, there is no galvanic contact between elongate radiating element 104 and tube 120. Conductive tube 120 thus forms a capacitive RF current path for RF current provided by RF connector 102.

It is appreciated by one skilled in the art that due to the elongate nature of elongate radiating element 104, antenna 100 generally resembles a whip-type monopole antenna. However, the provision in antenna 100 of both galvanic and capacitive current paths, respectively formed by elongate radiating element 104 and by tube 120 in conjunction with RF connector 102, leads to enhanced wideband performance of antenna 100 in comparison to conventional monopole whip antennas.

In operation of antenna 100, both elongate radiating element 104 and conductive tube 120 preferably act as radiating elements, due to the respective galvanic and capacitive RF current paths therealong. Antenna 100 may be adapted to operate over a wide variety of frequency ranges, including, by way of example only, 380-800 MHz.

It is appreciated that the frequency of operation of antenna 100 may be altered by way of modification of the geometric properties of elongate radiating element 104 and conductive tube 120, including modification of their respective heights and thicknesses and of the separation therebetween. It is understood that although conductive tube 120 is shown in FIG. 1B as extending parallel to and along the full length of elongate radiating element 104, conductive tube 120 may alternatively have a length shorter than that of elongate radiating element 104, provided that conductive tube 120 overlaps with a portion of RF connector 102 so as to maintain a capacitive coupling region therebetween.

Elongate radiating element 104 may be formed of any suitable conductive material and is preferably embodied as a flexible shaft cable. As seen in FIG. 1A, antenna 100 may be enclosed by an outer sheath 140 so as to enhance its durability and mechanical stability.

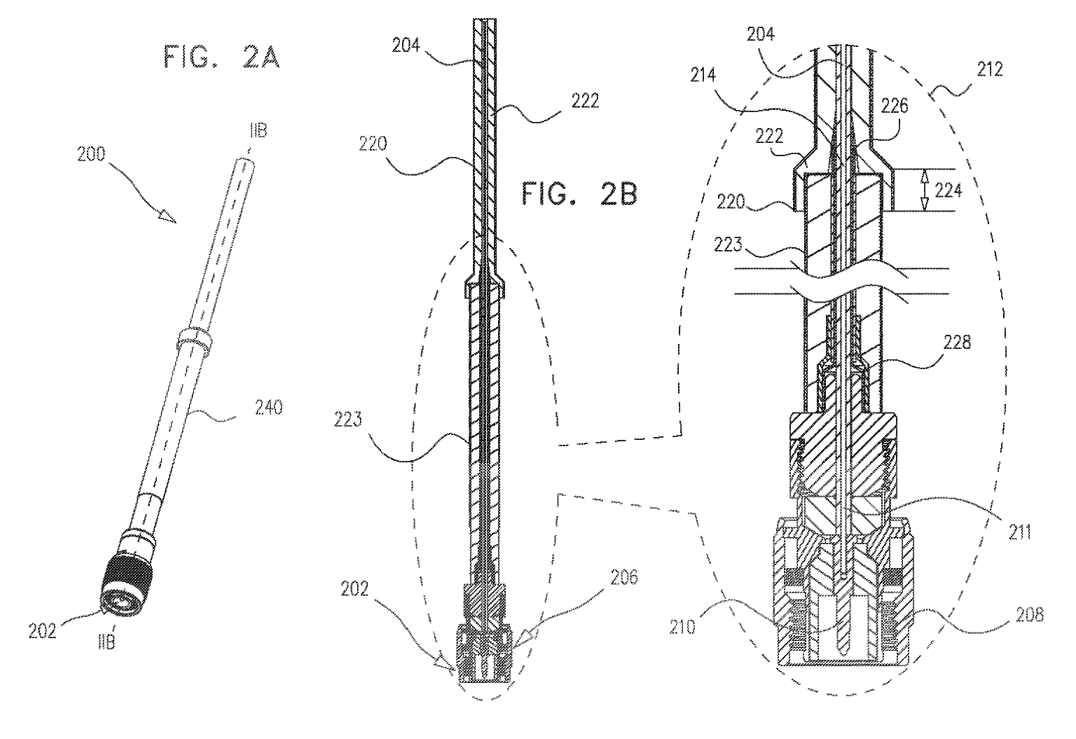

Reference is now made to FIGS. 2A and 2B, which are simplified respective perspective and cross-sectional view illustrations of an antenna constructed and operative in accordance with another preferred embodiment of the present invention.

As seen in FIGS. 2A and 2B, there is provided an antenna 200. Antenna 200 preferably includes an RF connector 202, providing an RF current to antenna 200, and an elongate radiating element 204 galvanically connected thereto. Here, by way of example, RF connector 202 is shown to be embodied as a coaxial connector 206 having a conductive outer connector body 208, a conductive inner pin 210 and an inner coaxial wire 211 galvanically connected to conductive inner pin 210. As seen most clearly at enlargement 212, elongate radiating element 204 is preferably embodied as a wire, galvanically connected at a base end 214 thereof to inner coaxial wire 211. In the illustrated embodiment of antenna 200 elongate radiating element 204 and inner coaxial wire 211 are shown to be formed as a single monolithic element having two functional parts respectively corresponding to elongate radiating element 204 and inner coaxial wire 211. It is appreciated, however, that elongate radiating element 204 may be formed as a conductive element separate from inner coaxial wire 211, whereby a bandwidth of antenna 200 may be improved

It is appreciated by one skilled in the art that due to the galvanic connection between RF connector 202 and elongate radiating element 204, elongate radiating element 204 forms a galvanic RF current path for the RF current provided by RF connector 202.

Antenna 200 further includes at least one generally cylindrical conductive element enclosing at least a portion of elongate radiating element 204, here embodied, by way of example, as a cylindrical conductive tube 220 coextensive with elongate radiating element 204 and separated therefrom by a dielectric spacer 222. Tube 220 preferably extends beyond base end 214 of elongate radiating element 204, so as to overlap with a portion of a balun 223 in overlap region 224. Balun 223 is preferably galvanically connected to a coaxial braid 226, which coaxial braid 226 is in turn preferably galvanically connected to outer connector body 208 in region 228.

As best seen at enlargement 212, the structure formed in overlap region 224 by overlapping conductive tube 220 and balun 223, separated by dielectric spacer 222, is a capacitive structure, leading to capacitive coupling between balun 223 and conductive tube 220. Preferably, there is no galvanic contact between elongate radiating element 204 and tube 220. Conductive tube 220 thus forms a capacitive RF current path for RF current provided by RF connector 202, which capacitive RF current path preferably includes balun 223.

It is appreciated by one skilled in the art that due to the arrangement of elongate radiating element 204 and balun 223, antenna 200 generally resembles a sleeve-dipole type antenna, in which elongate radiating element 204 acts as a first dipole arm and balun 223 acts as a second dipole arm. However, the provision in antenna 200 of both galvanic and capacitive current paths leads to enhanced wideband performance of antenna 200 in comparison to conventional sleeve-dipole antennas.

In operation of antenna 200, elongate radiating element 204 in combination with balun 223 preferably form a dipole radiating element due to the galvanic RF current path therealong. Furthermore, conductive tube 220 preferably acts as an additional radiating element due to the capacitive RF current path therealong. Antenna 200 may be adapted to operate over a wide variety of frequency ranges, including, by way of example only, 800-1000 MHz.

It is appreciated that the frequency of operation of antenna 200 may be altered by way of modification of the geometric properties of elongate radiating element 204, conductive tube 220 and balun 223, including modification of their respective heights and thicknesses and of the separation therebetween. It is understood that although conductive tube 220 is shown in FIG. 2B as extending in parallel to and along the full length of elongate radiating element 204, conductive tube 220 may alternatively have a length shorter than that of elongate radiating element 204, provided that conductive tube 220 overlaps with a portion of balun 223 so as to maintain a region of capacitive coupling therebetween.

Elongate radiating element 204 may be formed of any suitable conductive material and is preferably embodied as a tin-plated copper wire. As seen in FIG. 2A, antenna 200 may be enclosed by an outer sheath 240 so as to enhance its durability and mechanical stability.

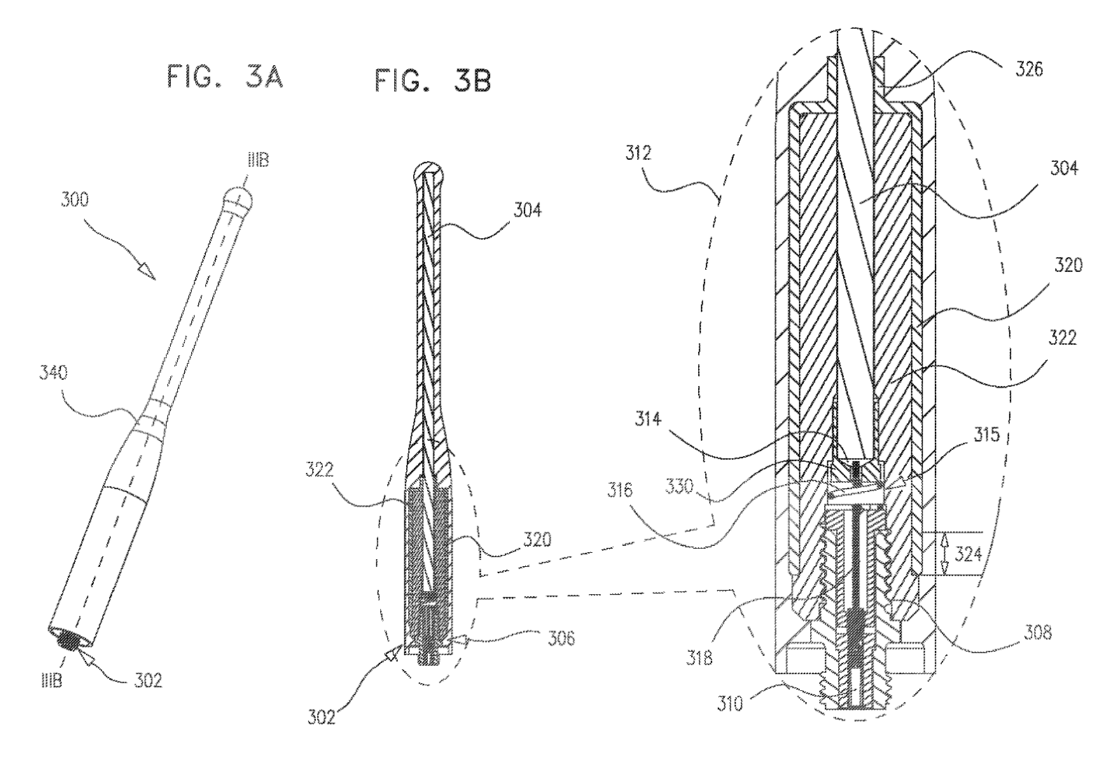

Reference is now made to FIGS. 3A and 3B, which are simplified respective perspective and cross-sectional view illustrations of an antenna constructed and operative in accordance with a further preferred embodiment of the present invention.

As seen in FIGS. 3A and 3B, there is provided an antenna 300. Antenna 300 preferably includes an RF connector 302 providing an RF current to antenna 300, and an elongate radiating element 304 galvanically connected thereto. Here, by way of example, RF connector 302 is shown to be embodied as a coaxial connector 306 having a conductive outer connector body 308 and a conductive inner pin 310. As seen most clearly at enlargement 312, elongate radiating element 304 is preferably galvanically connected at a base end 314 thereof to a matching structure 315, which matching structure preferably includes a coil 316. Coil 316 is preferably galvanically connected by way of a conductive arm 318 to inner pin 310 of coaxial connector 306.

It is appreciated by one skilled in the art that due to the galvanic connection between inner pin 310 of RF connector 302 and elongate radiating element 304, by way of matching structure 315 and conductive arm 318, elongate radiating element 304 forms a galvanic RF current path for the RF current provided by RF connector 302.

Antenna 300 further includes at least one generally cylindrical conductive element enclosing at least a portion of elongate radiating element 304, here embodied, by way of example, as a cylindrical conductive choke 320 surrounding a lower portion of elongate radiating element 304 proximal to base end 314. Choke 320 is preferably separated from elongate radiating element 304 by a dielectric spacer 322. Choke 320 preferably extends beyond base end 314 of elongate radiating element 304 so as to overlap with a portion of outer connector body 308 in overlap region 324. Choke 320 preferably terminates in a tapered segment 326 encircling a circumference of elongate radiating element 304.

As best seen at enlargement 312, the structure formed in overlap region 324 by mutually overlapping choke 320 and conductive outer connector body 308, separated by dielectric spacer 322, is a capacitive structure, leading to capacitive coupling between outer connector body 308 and choke 320. Choke 320 thus forms a capacitive RF current path for RF current provided by RF connector 302.

It is appreciated by one skilled in the art that due to the elongate nature of elongate radiating element 304, antenna 300 generally resembles a whip-type monopole antenna. However, the provision in antenna 300 of both galvanic and capacitive current paths, respectively formed by elongate radiating element 304 and by choke 320 in conjunction with RF connector 302, leads to enhanced wideband performance of antenna 300 in comparison to conventional monopole whip antennas.

In operation of antenna 300, elongate radiating element 304 preferably operates as wideband multiband antenna having lower and upper frequency bands of operation. The lower frequency band of operation of antenna 300 preferably comprises a continuous band spanning approximately 380-900 MHz. The upper frequency bands of operation of antenna 300 may include a 1575 MHz band and/or a 2.4-2.5 GHz band, depending on the quarter-wavelength integer-multiple effective electrical length of elongate radiating element 304. It is understood, however, that these specific frequency values for the lower and upper frequency bands of operation of antenna 300 are exemplary only and that antenna 300 may be adapted to operate over a variety of frequency ranges.

The continuous ultra-broadband 380-900 MHz lower operational band of antenna 300 may be attributed to the presence of the capacitive RF current path provided by choke 320. Thus, in addition to elongate radiating element 304 receiving RF current by way of the galvanic connection thereof to RF connector 302 via matching structure 315, elongate radiating element 304 preferably also receives RF current by way of the capacitive RF current path formed by choke 320. Choke 320 may thus be considered to form a portion of a capacitive feed arrangement for feeding elongate radiating element 304.

It is a particular feature of a preferred embodiment of the present invention that choke 320, in addition to forming a part of the feeding structure of antenna 300, also contributes to the matching structure 315 for elongate radiating element 304 in the lower operational band of antenna 300. The matching structure 315 for elongate radiating element 304 preferably includes coil 316, a conductive bushing 330 and choke 320. It is understood, however, that matching structure 316 may include additional or alternative inductive elements. It is further appreciated that although coil 316 is illustrated in FIG. 3B as comprising a single turn, the number and radii of the turns of coil 316 may be varied according to the operational requirements of antenna 300. Matching structure 315 serves to match the naturally high impedance of elongate radiating element 304 to the lower input impedance of RF connector 302.

It will be apparent to one skilled in the art that the 1575 MHz upper frequency band of operation of antenna 300 corresponds to the frequency band used in Global Positioning Systems (GPS). Antenna 300 is particularly well suited for use in GPS applications due to its radiation pattern in the 1575 MHz band. In contrast to conventional whip antennas, which conventional whip antennas typically radiate predominantly in the azimuth, antenna 300 has a radiation pattern that is primarily directed upwards at 1575 MHz. The altered GPS radiation pattern of antenna 300 in comparison to that of conventional whip antennas is due to the fact that in operation at 1575 MHz the entire length of antenna 300, including elongate element 304 and choke 320, effectively functions as a radiating element, rather than radiating element 304 or choke 320 alone acting as the radiating element. This leads to a changed radiation pattern in comparison to that of conventional whip antennas, resulting in antenna 300 being particularly well suited to GPS applications, in which at least a portion of radiation is preferably directed upwards.

It is appreciated that the frequency of operation of antenna 300 may be altered by way of modification of the geometric properties of elongate radiating element 304 and choke 320, including modification of their respective heights and thicknesses and of the separation therebetween. It has been found that a preferred length of choke 320 corresponds to approximately a quarter-wavelength of the upper band of operation of antenna 300. However, the exact length of choke 320 is preferably selected so as to optimize the impedance matching of elongate radiating element 304 to RF connector 302, since choke 320 forms a part of the matching structure 315 for elongate radiating element 304.

As seen in FIG. 3A, antenna 300 may be enclosed by an outer sheath 340 so as to enhance its durability and mechanical stability. Elongate radiating element 304 may be formed of any suitable conductive material and is preferably embodied as a flexible shaft cable.

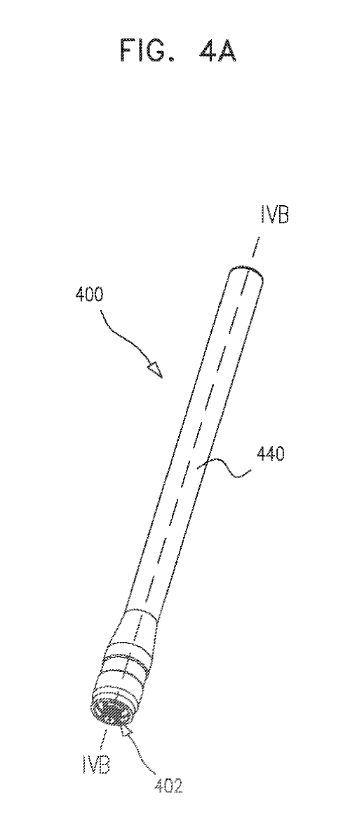

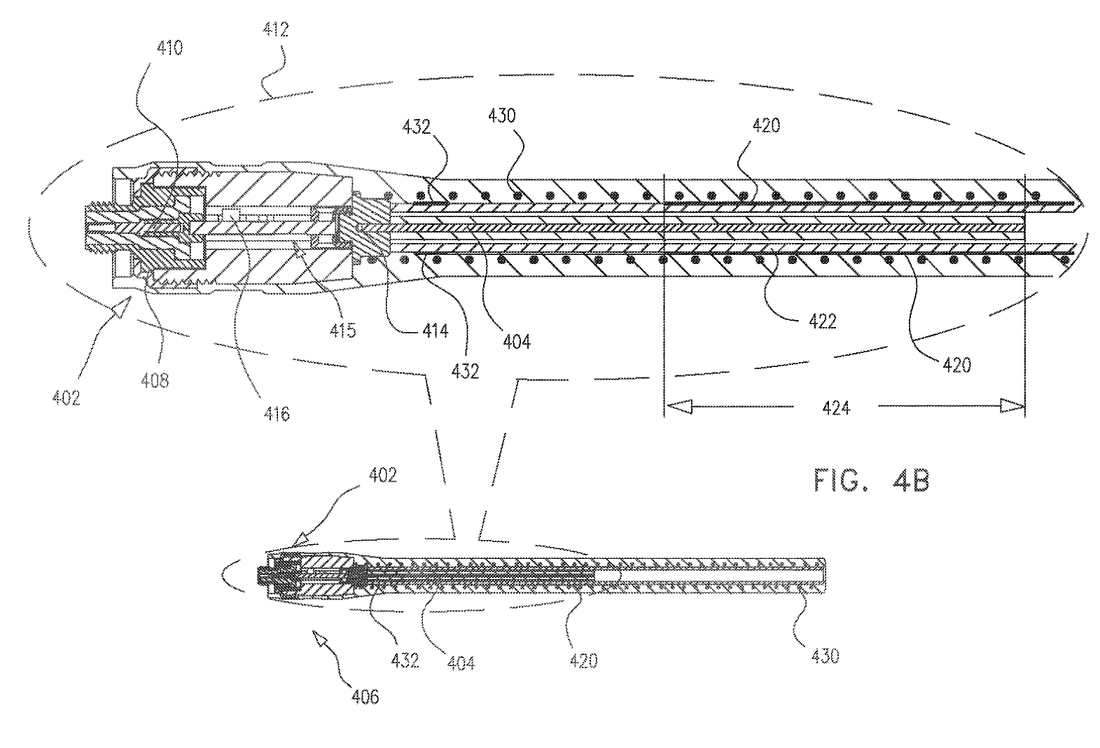

Reference is now made to FIGS. 4A and 4B, which are simplified respective perspective and cross-sectional view illustrations of an antenna constructed and operative in accordance with yet another preferred embodiment of the present invention.

As seen in FIGS. 4A and 4B, there is provided an antenna 400. Antenna 400 preferably includes an RF connector 402 providing an RF current to antenna 400, and an elongate radiating element 404 galvanically connected thereto. Here, by way of example, RF connector 402 is shown to be embodied as a coaxial connector 406 having a conductive outer connector body 408 and a conductive inner pin 410. As seen most clearly at enlargement 412, elongate radiating element 404 is preferably galvanically connected at a base end 414 thereof to a matching structure 415, which matching structure 415 preferably includes an inductor 416. Inductor 416 is preferably galvanically connected to inner pin 410 of coaxial connector 406.

It is appreciated that the formation of matching structure 415 by inductor 416 is exemplary only and that matching structure 415 may include a variety of reactive elements. Matching structure 415 is particularly preferably embodied as a lumped-element matching circuit of a type described in PCT Application No. PCT/IL2013/050263, assigned to the same assignee as the present invention.

It is appreciated by one skilled in the art that due to the galvanic connection between RF connector 402 and elongate radiating element 404, by way of matching structure 415, elongate radiating element 404 forms a galvanic RF current path for the RF current provided by RF connector 402.

Antenna 400 further includes at least one generally cylindrical conductive element enclosing at least a portion of elongate radiating element 404, here embodied, by way of example, as a conductive sleeve 420 surrounding a part of elongate radiating element 404 and separated therefrom by a dielectric spacer 422. Sleeve 420 preferably overlaps with an upper portion of elongate radiating element 404 in overlap region 424.

The structure formed in overlap region 424 by mutually overlapping conductive sleeve 420 and elongate radiating element 404, separated by dielectric spacer 422, is a capacitive structure, leading to capacitive coupling between elongate radiating element 404 and conductive sleeve 420. Preferably, there is no galvanic contact between elongate radiating element 404 and sleeve 420. Conductive sleeve 420 thus forms a capacitive RF current path for RF current provided by RF connector 402, which capacitive current path preferably includes elongate radiating element 404.

Antenna 400 preferably additionally includes a helical radiating element 430 surrounding both elongate radiating element 404 and conductive sleeve 420. Helical radiating element 430 is preferably galvanically connected to RF connector 402. Conductive sleeve 420 is preferably isolated from both helical radiating element 430 and inner elongate radiating element 404.

In operation of antenna 400, helical radiating element 430 preferably radiates in the VHF 136-174 MHz frequency band. Elongate radiating element 404 preferably capacitively couples to conductive sleeve 420 so as to form a composite radiating element preferably radiating in the upper 380-520 MHz and 780-870 MHz bands. Antenna 400 is thus a tri-band antenna, capable of operating in the VHF 136-174 MHz, 380-520 MHz and 780-870 MHz bands.

It is a particular feature of a preferred embodiment of the present invention that the upper frequency bands of operation of antenna 400 are preferably provided by a composite two-component radiating element formed by elongate radiating element 404 in combination with conductive sleeve 420. The use of a composite two-component radiating element in antenna 400 avoids the need for a single extremely long radiating element within helical radiating element 430, which single extremely long radiating element would cause significant losses in the VHF 136-174 MHz frequency band of operation of antenna 400.

It is a further particular feature of a preferred embodiment of the present invention that conductive sleeve 420, in addition to providing a capacitive RF current path, also serves to control current distribution along helical radiating element 430 by reducing the RF current in those sections of helical radiating element 430 to which it is adjacent. Conductive sleeve 420 thereby acts as a filter element with respect to helical radiating element 430. The effective electrical length of helical radiating element 430 in a given frequency band thus may be adjusted by way of modification of the location and/or width of conductive sleeve 420.

In order to further control RF current in elongate radiating element 404 and helical radiating element 430, antenna 400 may optionally include a second conductive sleeve 432, best seen at enlargement 412. Second conductive sleeve 432 is preferably spatially offset from first conductive sleeve 420 and serves to control RF current flow at a different frequency range and location in antenna 400 to that controlled by first conductive sleeve 420.

It is a particularly advantageous feature of a preferred embodiment of the present invention that due to the electrical interaction between helical radiating element 430, elongate radiating element 404 and first and second conductive sleeves 420 and 432, helical radiating element 430 is well matched to an input impedance of RF connector 402. The presence of elongate radiating element 404 and first and second conductive sleeves 420 and 432 serves to reduce the inherently large inductance of helical radiating element 430, thus improving the impedance match of helical radiating element 430 to a 50 Ohm input impedance of antenna 400. Were it not for the provision of elongate radiating element 404 and conductive sleeves 420 and 432, the inherently large inductance of helical radiating element 430 would render helical radiating element 430 poorly matched to a 50 Ohm input impedance, thereby increasing input losses of antenna 400.

Elongate radiating element 404 may be formed of any suitable conductive material and is preferably embodied as a flexible shaft cable. As seen in FIG. 4A, antenna 400 may be enclosed by an outer sheath 440 so as to enhance its durability and mechanical stability.

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon reading the forgoing description with reference to the drawings and which are not in the prior art.

1. A wideband antenna comprising:
a radio-frequency connector providing a radio-frequency current;
an elongate radiating element galvanically connected to said radio-frequency connector, said elongate radiating element forming a galvanic radio-frequency current path for said radio-frequency current; and
at least one generally cylindrical conductive element enclosing at least a portion of said elongate radiating element and forming a capacitive radio-frequency current path for said radio-frequency current.

2. A wideband antenna according to claim 1, wherein said radio-frequency connector comprises a coaxial connector comprising a conductive outer connector body and a conductive inner pin.

3. A wideband antenna according to claim 2, wherein said elongate radiating element has a base end, said base end being galvanically connected to said conductive inner pin.

4. A wideband antenna according to claim 1, wherein said elongate radiating element is mounted on said radio-frequency connector.

5. A wideband antenna according to claim 2, wherein said elongate radiating element comprises a monopole.

6. A wideband antenna according to claim 5, wherein said at least one generally cylindrical conductive element comprises a conductive tube enclosing said monopole and separated therefrom by a dielectric spacer, said conductive tube overlapping with said conductive outer connector body so as to form said capacitive radio-frequency current path.

7. A wideband antenna according to any of the preceding claims, wherein there is no galvanic contact between said at least one generally cylindrical conductive element and said elongate radiating element.

8. A wideband antenna according to claim 2, wherein said radio-frequency connector also comprises an inner coaxial wire.

9. A wideband antenna according to claim 8, wherein said elongate radiating element has a base end, said base end being galvanically connected to said inner coaxial wire.

10. A wideband antenna according to claim 8 or claim 9, and also comprising a balun galvanically connected to said radio-frequency connector.

11. A wideband antenna according to claim 10, wherein said elongate radiating element forms a first arm of a dipole and said balun forms a second arm of said dipole.

12. A wideband antenna according to claim 10 or claim 11, wherein said at least one generally cylindrical conductive element comprises a conductive tube enclosing said elongate radiating element and separated therefrom by a dielectric spacer, said conductive tube overlapping with said balun so as to form said capacitive radio-frequency current path.

13. A wideband antenna according to claim 2, and also comprising a matching circuit for matching an impedance of said elongate radiating element to an impedance of said radio-frequency connector.

14. A wideband antenna according to claim 13, wherein said at least one generally cylindrical conductive element comprises a conductive choke, said conductive choke enclosing a portion of said elongate radiating element and being separated therefrom by a dielectric spacer.

15. A wideband antenna according to claim 14, wherein said conductive choke overlaps with a portion of said conductive outer connector body so as to form said capacitive radio-frequency current path.

16. A wideband antenna according to claim 14, wherein said conductive choke forms a part of said matching circuit.

17. A wideband antenna according to claim 16, wherein said matching circuit also comprises a conductive bushing and a coil.

18. A wideband antenna according to claim 14, wherein said conductive choke capacitively feeds said elongate radiating element.

19. A wideband antenna according to claim 13, wherein said at least one generally cylindrical conductive element comprises at least one conductive sleeve enclosing a portion of said elongate radiating element and separated therefrom by a dielectric spacer.

20. A wideband antenna according to claim 19, and also comprising a helical radiating element surrounding said elongate radiating element and said at least one conductive sleeve.

21. A wideband antenna according to claim 20, wherein said at least one conductive sleeve filters said radio-frequency current along said helical radiating element.

22. A wideband antenna according to claim 20, wherein said helical radiating element radiates in a first VHF 136-174 MHz frequency band.

23. A wideband antenna according to claim 20, wherein said elongate radiating element is capacitively coupled to said at least one conductive sleeve to form a composite high frequency radiating element.

24. A wideband antenna according to claim 20, wherein said antenna is a tri-band antenna.

25. A wideband antenna comprising:
a radio-frequency connector providing a radio-frequency current;
a monopole radiating element galvanically connected to said radio-frequency connector, said monopole radiating element forming a galvanic radio-frequency current path for said radio-frequency current; and
a tubular conductive radiating element enclosing at least a portion of said monopole radiating element and forming a capacitive radio-frequency current path for said radio-frequency current.

26. A wideband antenna comprising:
a radio-frequency connector providing a radio-frequency current;
an elongate radiating element galvanically connected to said radio-frequency connector, said elongate radiating element forming a first arm of a dipole and providing a galvanic radio-frequency current path for said radio-frequency current;
a balun galvanically connected to said radio-frequency connector, said balun forming a second arm of said dipole; and
a generally cylindrical conductive radiating element enclosing at least a portion of said elongate radiating element and forming a capacitive radio-frequency current path for said radio-frequency current.

27. A wideband antenna comprising:
a radio-frequency connector providing a radio-frequency current;
a monopole radiating element galvanically connected to said radio-frequency connector, said monopole radiating element forming a galvanic radio-frequency current path for said radio-frequency current; and
a conductive choke enclosing at least a portion of said monopole radiating element and said radio-frequency connector and forming a capacitive radio-frequency current path for said radio-frequency current.

28. A wideband antenna comprising:
a radio-frequency connector providing a radio-frequency current;
an elongate radiating element galvanically connected to said radio-frequency connector, said elongate radiating element forming a galvanic radio-frequency current path for said radio-frequency current;
a helical radiating element galvanically connected to said radio-frequency connector and surrounding said elongate radiating element; and
at least one cylindrical conductive element enclosing at least a portion of said elongate radiating element and forming a capacitive radio-frequency current path for said radio-frequency current.
